(19) United States
(12) Patent Application Publication
(10) Pub. No.: US 2015/0170855 A1
(43) Pub. Date: Jun. 18, 2015

(54) POWER WINDOW SWITCH FOR VEHICLE

(71) Applicant: Huyndai Motor Company, Seoul (KR)

(72) Inventor: Hong Min Lee, Seoul (KR)

(73) Assignee: Hyundai Motor Company, Seoul (KR)

(21) Appl. No.: 14/326,156

(22) Filed: Jul. 8, 2014

(30) Foreign Application Priority Data
Dec. 18, 2013 (KR) 10-2013-0157740

(51) Int. Cl. H01H 21/08

(52) U.S. Cl. CPC H01H 21/08; H01H 2300/01; H01H 2223/044

(57) ABSTRACT

A power window switch for a vehicle may include a window switch with a knob on a top of the window switch to open/close a door glass of the vehicle, a switch cover partially exposing the knob and partially covering the knob and the window switch, a drain hole formed through a side of the switch cover, and a hole cover extending toward the drain hole from the knob to close the drain hole or opening the drain hole in accord with movement of the knob.

### CROSS-REFERENCE TO RELATED APPLICATION

The present application claims priority of Korean Patent Application Number 10-2013-0157740 filed on December 18, 2013, the entire contents of which application are incorporated herein for all purposes by this reference.

### BACKGROUND OF INVENTION

1. Field of Invention

The present invention relates to a power window switch for a vehicle, and more particularly, to a power window switch for a vehicle which has a drain outlet that can be opened/closed.

2. Description of Related Art

In vehicles recently coming into the market, the windows of the doors are opened/closed by operating power window switches respectively on the doors. Although the operation of power window switches may be different, depending on the manufacturers or the type of vehicles, the windows are opened and closed, when the power window switches are operated in different directions.

Those power window switches are each generally composed of a knob that protrudes outward for a passenger to operate it and a switch module on which the knob is fixed and which operates a window actuating motor in the door in response to the operation of the knob, and a switch housing that covers the knob is disposed on the top of the switch module.

Further, a drain hole for discharging water that flows into the switch housing through the knob protruding outward is formed in the switch housing and discharges water flowing inside to the outside.

However, since the drain hole is always open, the air in the housing flows out to the interior of the vehicle due to a pressure change in the vehicle when the vehicle travels, so that actually external air does not flow inside, but passengers feel like air flows to the inside from the outside and feel uncomfortable and dissatisfied.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide a power window switch for a vehicle which prevents air therein from flowing out to the interior of a vehicle in normal times by opening or closing a drain hole, depending on whether it operates.

Various aspects of the present invention provide a power window switch for a vehicle, which may include a window switch with a knob on a top of the window switch to open/close a door glass of the vehicle, a switch cover partially exposing the knob and partially covering the knob and the window switch, a drain hole formed through a side of the switch cover, and a hole cover extending toward the drain hole from the knob to close the drain hole or opening the drain hole in accord with movement of the knob.

The knob may be coupled to the top of the window switch pivotably at one end. The drain hole may be formed under the other end of the knob, on the side of the switch cover. The hole cover may extend down from the other end of the knob and may be formed in a shape of a panel to cover the drain hole. The hole cover may open the drain hole by moving up with upward movement of the knob. An insertion groove may be formed at a position, which faces the hole cover, on the top of the window switch to facilitate insertion of at least a portion of the hole cover when the hole cover is moved down by downward movement of the knob.

According to the power window switch for a vehicle of the present invention, it is possible to prevent air in the switch cover from being discharged to the interior of a vehicle through the drain hole by opening the drain hole only when it is necessary, and accordingly, it is possible to increase the commercial value of a vehicle. Further, since the structure is simple, there is no concern of malfunction, and it is possible to completely discharge water, when the drain hole is open.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other features of the present invention will now be described in detail with reference to certain exemplary embodiments thereof illustrating the accompanying drawings which are given herein below by way of illustration only, and thus are not limitative of the present invention, and wherein:

FIG. 1 is a view illustrating a configuration of an exemplary power window switch for a vehicle according to the present invention;

FIG. 2 is a view showing an exemplary power window switch for a vehicle according to the present invention in normal times;

FIG. 3 is a view showing an exemplary power window switch for a vehicle according to the present invention, when a hole cover moves up; and

FIG. 4 is a view showing an exemplary power window switch for a vehicle according to the present invention, when the hole cover moves down.

It should be understood that the appended drawings are not necessarily to scale, presenting a somewhat simplified representation of various preferred features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

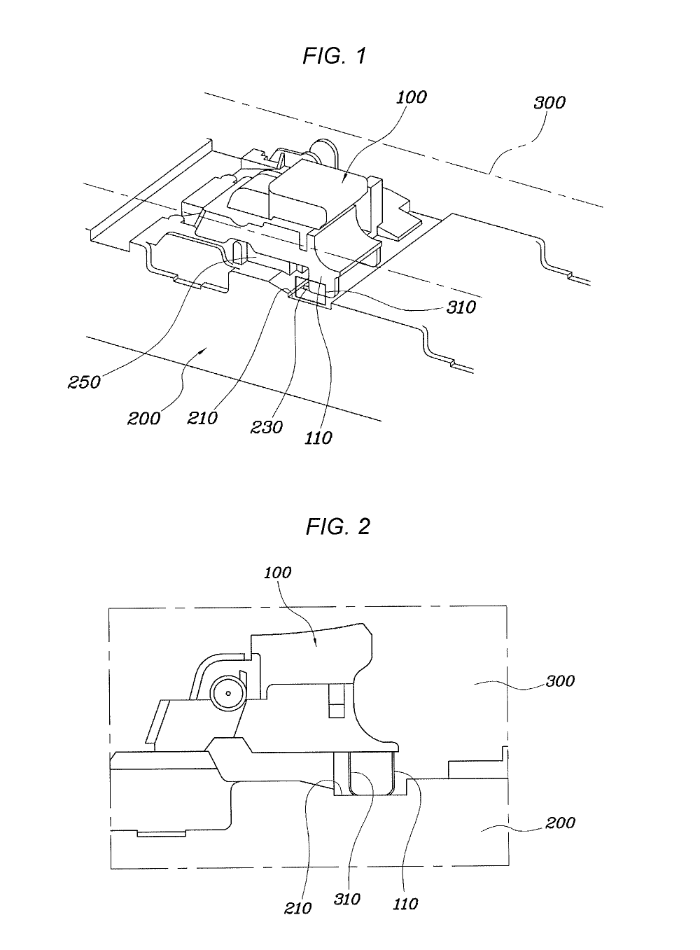

FIG. 1 is a view illustrating a configuration of a power window switch for a vehicle according to various embodiments of the present invention. The power window switch for a vehicle according to various embodiments of the present invention includes: a window switch 200 with a knob 100 on the top to open/close a door glass of a vehicle; a switch cover 300 partially exposing the knob 100 and partially covering the knob 100 and the window switch 200; a drain hole 310 formed through a side of the switch cover 300; and a hole cover 110 extending toward the drain hole 310 from the knob 100 to close the drain hole 310 and opening the drain hole 310 by moving with movement of the knob 100.

In detail, the window switch 200 is disposed on a door of a vehicle or the center fascia of a vehicle or the like, and sends a control signal to a motor in the door to move up/down a door glass when the knob 100 is operated. The outer part may be made of plastic in a rectangular box or the like.

The knob 100 may be on the top of the window switch 200 and partially exposed outside the switch cover 300 and a user can operate the knob 100 through the exposed portion of the knob 100.

The knob 100 may be coupled to the top of the window switch 200 pivotably at one end, a coupling protrusion 250 is provided on the top of the window switch 200 to be able to fix the end of the knob 100, and the coupling protrusion 250 and the end of the knob 100 may be coupled such as by a hinge pin so that the knob 100 can pivot on the end. Accordingly, when a passenger operates the exposed portion of the knob 100 and the other end of the knob 100 is pivoted up/down by this operation of the passenger. The operation structures of the knob 100 and the window switch 200 may be similar or the same as those of the related art.

The switch cover 300 covers potions of the knob 100 and the window switch 200 while partially exposing the knob 100, but it may fully cover the window switch 200 or may be combined with the window switch 200 while covering or partially covering the knob 100 only.

The drain hole 310 is preferably formed under the other end of the knob 100, on the side of the switch cover 300, a drain groove 210 is laterally formed on the top of the window switch 200, at a position corresponding to the other end of the knob 100, and the drain hole 310 is formed through the switch cover 300 facing both ends of the drain groove 210; and therefore the water flowing inside through the knob 100 can be discharged through the drain hole 310 along the drain groove 210. For reference, the lateral direction is the direction perpendicular to the longitudinal direction of the window switch 200.

The drain hole 310 may be formed through both sides of the window cover, but may be formed only through the side facing the interior of a vehicle.

The hole cover 110 extends down from the other end of the knob 100, and as shown in FIG. 2, it may be formed in the shape of a panel to cover the drain hole 310.

The hole cover 110 is wide enough to fully cover the drain hole 310 and when the hole cover 110 covers the drain hole 310, it may be in contact with the inner side of the switch cover 300 where the drain hole 310 is formed to prevent the air in the switch cover 300 from being discharged to the interior of a vehicle or it may keep a short distance enough to stop flow of the air. If there is a gap between the knob 100 and the inner side of the switch cover 300 where the drain hole 310 is formed, the hole cover 110 may partially bend toward the inner side of the switch cover 300 where the drain hole 310 is formed to cover the drain hole 310.

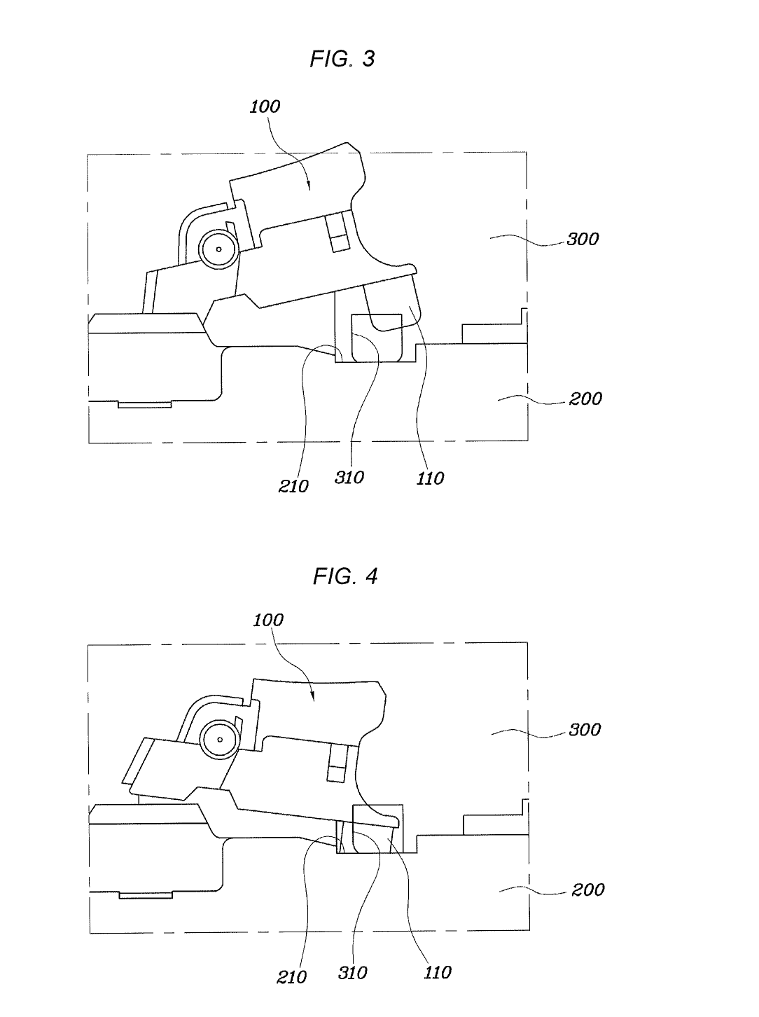

Since the hole cover 110 extends down from the other end of the knob 100, as shown in FIG. 3, the hole cover 110 opens the drain hole 310 by moving with the knob 100 moving up. Accordingly, the hole cover 110 covers the drain hole 310 in normal times, but when a passenger operates the knob 100 and the knob 100 pivots upward, the hole cover 110 opens the drain hole 310 and the air in the switch cover 300 is prevented from being discharged to the interior. Further, water in the switch cover 300 can be discharged every time the knob 100 is operated, so damage to the knob 100 and the window switch 200 due to the water in the switch cover is prevented.

Further, an insertion groove 230 may be formed at a position, which faces the hole cover 110, on the top of the window switch 200 so that the hole cover 110 can be inserted when the hole cover 110 is moved down by downward movement of the knob 100. That is, as shown in FIGS. 1 and 4, an insertion groove 230 is formed on the top of the window switch 200 so that the drain hole 310 can be opened when the knob 100 pivots down too. Accordingly, the insertion groove 230 is formed so that a portion of the lower end of the hole cover 110 can be inserted into the groove, and thus the drain hole 310 can be opened when the knob 100 is moved upward. To this end, although the hole cover 110 fully covers the drain hole 310, it may be wide enough to open the drain hole 310 when the knob 100 is moved upward.

Since the drain hole 310 is opened even when the knob 100 is moved down, the cycle of opening the drain hole 310 may be shorter than that when the drain hole 310 is opened only when the knob 100 is moved up, and accordingly, it is possible to prevent malfunction of the window switch 200 and the knob 100 by reducing the time that the water in the switch cover 300 remains therein.

According to the power window switch for a vehicle of the present invention, it is possible to prevent air in the switch cover 300 from being discharged to the interior of a vehicle through the drain hole 310 by opening the drain hole 310 only when it is necessary, and accordingly, it is possible to increase the merchantability of a vehicle. Further, since the structure of the present invention is simple, there is no concern of malfunction, and it is possible to completely discharge water, when the drain hole 310 is open.

For convenience in explanation and accurate definition in the appended claims, the terms “upper” or “lower”, “inside” or “outside”, “up” or “down”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A power window switch for a vehicle, comprising:
a window switch with a knob on a top of the window switch to open/close a door glass of the vehicle;
a switch cover partially exposing the knob and partially covering the knob and the window switch;
a drain hole formed through a side of the switch cover; and
a hole cover extending toward the drain hole from the knob to close the drain hole or opening the drain hole in accord with movement of the knob.

2. The power window switch of claim 1, wherein the knob is coupled to the top of the window switch pivotably at one end.

3. The power window switch of claim 2, wherein the drain hole is formed under the other end of the knob, on the side of the switch cover.

4. The power window switch of claim 3, wherein the hole cover extends down from the other end of the knob and is formed in a shape of a panel to cover the drain hole.

5. The power window switch of claim 4, wherein the hole cover opens the drain hole by moving up with upward movement of the knob.

6. The power window switch of claim 4, wherein an insertion groove is formed at a position, which faces the hole cover, on the top of the window switch to facilitate insertion of at least a portion of the hole cover when the hole cover is moved down by downward movement of the knob.
